(19) United States
(12) Patent Application Publication
(10) Pub. No.: US 2026/0044843 A1
(43) Pub. Date: Feb. 12, 2026

(54) SYSTEMS AND METHODS FOR ENHANCING POINT-OF-SALE INFORMATION

(71) Applicant: JPMORGAN CHASE BANK, N.A., New York, NY (US)

(72) Inventors: Andrew HOPKINS, Wilmington, DE (US); Matthew LANSDELL, Worthington, OH (US); Gautham PAVULURI, Holmdel, NJ (US); Jacob DODD, Delaware, DE (US); Anil GUDIMETLA, Lewis Center, OH (US); Nathaniel BRENEMAN, Powell, OH (US)

(21) Appl. No.: 18/799,476

(22) Filed: Aug. 9, 2024

(51) Int. Cl. G06Q 20/20

(52) U.S. Cl. CPC G06Q 20/204

(57) ABSTRACT

Systems and methods for s enhancing point of sale information are disclosed. In one embodiment, a method may include: (1) receiving, by a computer program, raw transaction data for a transaction, the transaction data comprising merchant fields, wherein the raw transaction data comprises payment card data for a payment card that was received at a point-of-sale device during a transaction between a customer and a merchant; (2) performing, by the computer program, data normalization on the merchant fields; (3) identifying, by the computer program, the merchant for the transaction based on one or more of the merchant fields; (4) enriching, by the computer program, a transaction record for the transaction with information for the merchant; and (5) outputting, by the computer program, the transaction record.

### BACKGROUND OF THE INVENTION

### 1. Field of the Invention

Embodiments generally relate to systems and methods for enhancing point-of-sale information.

### 2. Description of the Related Art

Merchant business names and associated data (e.g., merchant phone numbers, uniform resource locators (URLs), etc.) is often confusing and unintelligible when received from point-of-sale payment processors. An issuer's customers, service center agents, and data analysts, may have a difficult time understanding this information, making it difficult to understand where money is spent.

### SUMMARY OF THE INVENTION

Systems and methods for s enhancing point of sale information are disclosed. In one embodiment, a method may include: (1) receiving, by a computer program, raw transaction data for a transaction, the transaction data comprising merchant fields, wherein the raw transaction data comprises payment card data for a payment card that was received at a point-of-sale device during a transaction between a customer and a merchant; (2) performing, by the computer program, data normalization on the merchant fields; (3) identifying, by the computer program, the merchant for the transaction based on one or more of the merchant fields; (4) enriching, by the computer program, a transaction record for the transaction with information for the merchant; and (5) outputting, by the computer program, the transaction record.

In one embodiment, the data normalization may include removing, from the raw data, store numbers and order numbers.

In one embodiment, the data normalization may include replacing, from the raw data, abbreviated or truncated words in the raw data with full words.

In one embodiment, the merchant may be identified using string distance matching on the raw transaction data.

In one embodiment, the merchant may be identified using a decision tree with natural language processing.

In one embodiment, enriching the transaction record with information for the merchant may include adding merchant contact information for the merchant and/or adding merchant location information for the merchant to the transaction record.

In one embodiment, enriching the transaction record with information for the merchant may include adding a parent for the merchant to the transaction record.

In one embodiment, the merchant may be identified based on a merchant name matching a regular expression for the merchant name and the merchant fields matching a merchant city, a merchant state, and a merchant postal code for the merchant.

In one embodiment, the method may also include: identifying, by the computer program, an intermediary prefix in one of the merchant fields; identifying, by the computer program, an intermediary associated with the intermediary prefix; and enriching, by the computer program, the transaction record for the transaction with information for the intermediary.

In one embodiment, enriching the transaction record with information for the intermediary may include adding an intermediary identifier for the intermediary to the transaction record.

According to another embodiment, a non-transitory computer readable storage medium may include instructions stored thereon, which when read and executed by one or more computer processors, cause the one or more computer processors to perform steps comprising: receiving raw transaction data for a transaction, the transaction data comprising merchant fields, wherein the raw transaction data comprises payment card data for a payment card that was received at a point-of-sale device during a transaction between a customer and a merchant; performing data normalization on the merchant fields; identifying the merchant for the transaction based on one or more of the merchant fields; enriching a transaction record for the transaction with information for the merchant; and outputting the transaction record.

In one embodiment, the data normalization may include removing, from the raw data, store numbers and order numbers.

In one embodiment, the data normalization may include replacing, from the raw data, abbreviated or truncated words in the raw data with full words.

In one embodiment, the merchant may be identified using string distance matching on the raw transaction data.

In one embodiment, the merchant may be identified using a decision tree with natural language processing.

In one embodiment, enriching the transaction record with information for the merchant may include adding merchant contact information for the merchant and/or adding merchant location information for the merchant to the transaction record.

In one embodiment, enriching the transaction record with information for the merchant may include adding a parent for the merchant to the transaction record.

In one embodiment, the merchant may be identified based on a merchant name matching a regular expression for the merchant name and the merchant fields matching a merchant city, a merchant state, and a merchant postal code for the merchant.

In one embodiment, the non-transitory computer readable storage medium may also include instructions stored thereon, which when read and executed by the one or more computer processors, cause the one or more computer processors to perform steps comprising: identifying an intermediary prefix in one of the merchant fields; identifying an intermediary associated with the intermediary prefix; and enriching the transaction record for the transaction with information for the intermediary.

In one embodiment, enriching the transaction record with information for the intermediary may include adding an intermediary identifier for the intermediary to the transaction record.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for enhancing point-of-sale information according to an embodiment;

FIG. 2 depicts a method for enhancing point-of-sale information according to an embodiment; and

FIG. 3 depicts an exemplary computing system for implementing aspects of the present disclosure.

### DETAILED DESCRIPTION OF PREFERRED EMBODIMENTS

Systems and methods for enhancing point-of-sale information are disclosed.

Embodiments may provide a rules engine that uses a catalogue of rules using Regular Expression (“RegEx”) code to identify specific merchants using two data inputs: a merchant name character string and a Merchant Category Code (MCC) provided by a payment network to match with a brand recognized name from a list of merchant names.

Next, embodiments may use enhanced string distance to take the best match among candidates with a matching industry, location, and similar name. To identify the candidate pool, an automated search may be performed within a list of merchants based on the merchant's zip code and the Standard Industry Classification (SIC) code most closely related to the merchant's MCC. The merchant's name (i.e., a character string) included with the transaction may then be compared using a string similarity algorithm.

Next, if a merchant name match is not achieved, embodiments may use a raw-cleansing process to ensure that confusing data attributes such as, order/store numbers or payment processor names, are removed from the merchant name; zip codes are recognizable by removing leading or trailing zeros; data is aligned to the correct data field (e.g., the merchant website address is located in the URL field, not the Merchant City field); etc.

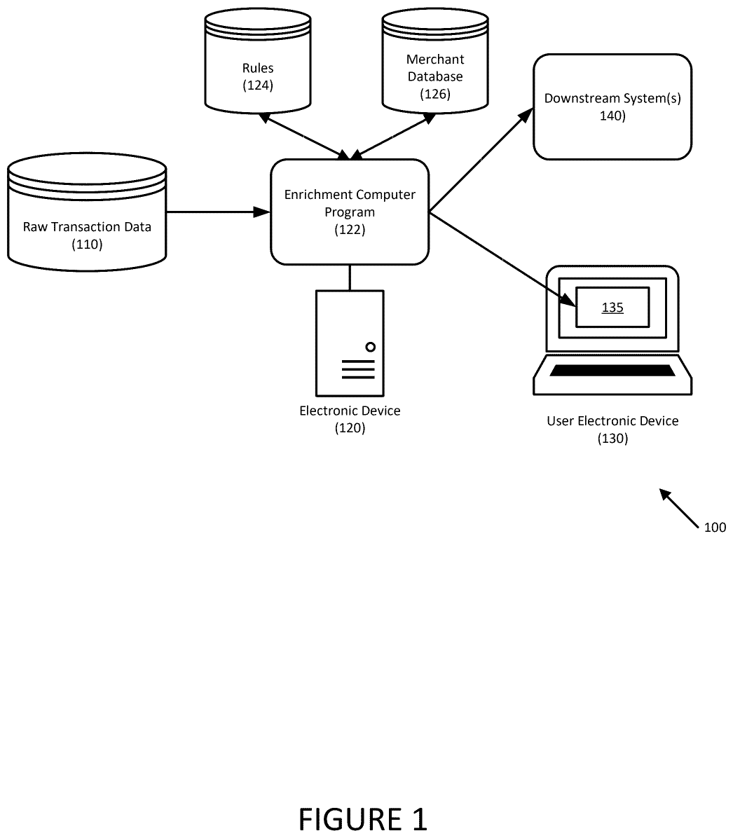

Referring to FIG. 1, a system for enhancing point-of-sale information is disclosed according to an embodiment. System 100 may include raw transaction data 110, which may include data from a merchant. Enrichment computer program 122, which may be executed by electronic device 120, may ingest the raw transaction data and may enrich the transaction data, resulting in an enriched value, before outputting it to computer program 135 that may be executed by user electronic device 130. User electronic device 130 may be associated with a customer, an employee of an issuer (e.g., a customer service agent), etc.

The enriched value, may also be provided to downstream systems 140, such as statement engines, etc.

Enrichment computer program 122 may pre-process the raw data before it is enriched. For example, enrichment computer program 122 may remove store numbers and order numbers from the raw data, may parse out any intermediary prefixes (e.g., a delivery provider for a food provider), may remove or replace special characters/symbols, may spell out abbreviated or truncated words, may remove insignificant words, may remove address strings, may remove phone numbers or URLs from raw city fields, etc.

Enrichment computer program 122 may receive rules from rules database 124, and may also receive merchant names from merchant database 126. Rules database 124 may include regular expressions that may be used to identify the merchant. For example, rules database 124 may include a name pattern and a list of merchant category codes. If the raw transaction data matches a rule, then a matching merchant may be identified using merchant database 126.

Merchant database 126 may include information for merchants, such as the merchant identifiers, merchant types, standardized merchant names, standardized merchant phone numbers, standardized merchant URLs, merchant SICs, merchant addresses, merchant latitude and longitude, third party business identifiers, third party logo identifiers, merchant logos, etc.

For some merchants, merchant database 126 may include a level 1 (e.g., headquarters) merchant record that may include headquarters information for the merchant, and one or more level 2 (e.g., location-based) merchant records for each merchant location. For example, a level 1 record may identify the parent for a merchant, and a level 2 record may identify a store location or an online merchant.

Enrichment computer program 122 may use string distance matching to identify the best match by matching industry and location. For example, the enrichment computer program may use the merchant's name, MCC, and zip code to identify potential matches, and may select the match with the highest probability.

For example, a candidate merchant may be determined to be a match if it reaches a positive terminating node in a decision tree (e.g., if the Jaccard weighted word score for that candidate is over 0.75 and the first three characters of the merchant names match, the candidate is a match). Certain terminating nodes in the tree may be prioritized based on an analysis of the statistical accuracy of that node (e.g., node 1 might have an accuracy of 99.7%, whereas node 4 an accuracy of 95%. In the case that node 1 and node 4 both find matches, the node with a higher accuracy, in this case node 1, is selected). The accuracy numbers may be determined from a review of test data that was run through the model.

Finally, if neither the rules-based matching nor the string distance matching is successful in identifying the merchant, the enrichment computer program 122 may perform raw cleansing on the raw transaction data, such as labeling the transaction data as only including cleansed data with no enrichment.

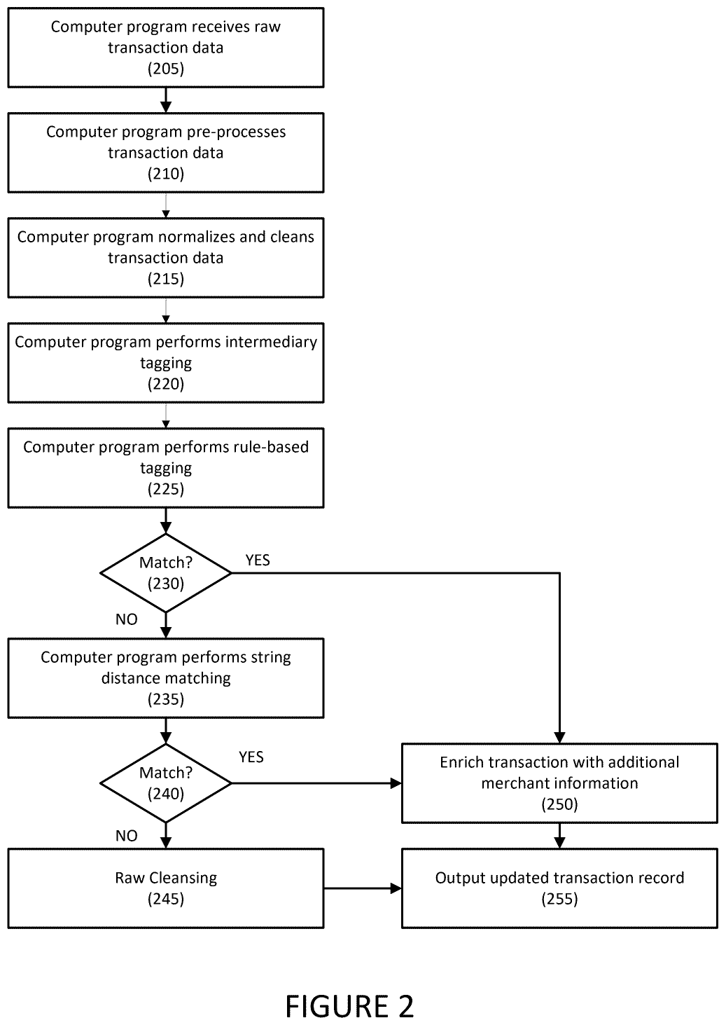

Referring to FIG. 2, a method for enhancing point-of-sale information is disclosed according to an embodiment.

In step 205, a computer program, such as an enhancement computer program, may receive raw transaction data for transactions. For example, payment card data may be received from a merchant point-of-sale device after being received from a customer by swiping, dipping, or otherwise presenting the payment card to the point-of-sale device. The merchant or the merchant's payment processor may add transaction data, merchant data, etc. to the payment card data, and may provide this raw transaction data to the computer program.

In step 210, the computer program may pre-process the transaction data. In one embodiment, the computer program may check key merchant fields to determine if each transaction can be enriched and is a point-of-sale transaction. For example, the computer program may check the merchant name, the merchant city, the merchant state, the merchant postal code, the MCC, the merchant ID, the merchant country code, the payment network transaction ID, etc., and may ensure that the transaction is a U.S. or travel-based transaction (e.g., using the MCC) or contains an intermediary. It may also validate the postal code (e.g., postal code range, postal code-state), and may validate that all fields are not null.

Next, in step 215, it may then perform data normalization and cleansing on the key merchant fields. This may include, for example, removing store numbers, order numbers, etc. from the raw data, parsing out any intermediary prefixes (e.g., a delivery provider, a payment service, etc.), removing or replacing special characters/symbols, spelling out abbreviated or truncated words, removing insignificant words, removing address strings, removing phone numbers or URLs from raw city fields, etc.

In step 220, the computer program may perform intermediary tagging on the transaction data. Intermediaries are go-between merchants that are a party to a transaction, but are not the primary merchant. Examples include payment services, delivery services, etc. A transaction may have multiple intermediaries, such as a payment service that conducted the payment, and a delivery service that delivered the goods.

In one embodiment, the computer program may match a regular expression from a rule against the transaction's intermediary name, and if a match is found, an entry may be added to the enriched value for that intermediary, which includes the intermediary ID. The process may be repeated until no matches are found.

For example, the rule may include a pattern that is associated with the intermediary name. For example, an intermediary may be identified using its name, an abbreviation of the name, different sequences of words in the intermediary name, etc. When a match is found, the computer program may create an enrichment entry in a list of enrichments that is created and maintained throughout the process; this may be referred to as the enriched value for the transaction. The enriched value may also include intermediary and merchant enrichments. Thus, for a transaction with a restaurant that includes a payment service and a delivery service, the enriched value may include all of the intermediary details for the payment service and delivery service. The enrichment information for the restaurant may be added to the enriched value later.

In step 225, the computer program may perform rule-based tagging on the enriched value. For example, the computer program may receive rules from a rules database as well as merchant information (e.g., the merchant name, the merchant city, the merchant state, the merchant postal code, the MCC, the merchant ID, the merchant country code, the payment network transaction ID, etc.) from a merchant database. The tags may be added to the enriched value. Thus, the transaction may be considered to be partially enriched.

The computer program may evaluate the merchant rules on a rule-by-rule basis. Merchant rules may be similar to the intermediary rules described above, except that intermediary rules may be accompanied by an end merchant (e.g., a delivery service must accompany a merchant, such as a restaurant). A transaction can only have one end merchant, whereas a transaction may include multiple intermediaries.

The mechanics of tagging are the same. The merchant name must match the regular expression of the rule, and optionally the merchant city, the merchant state, the merchant postal code, the MCC, the merchant ID, the merchant country code, etc.

For example, once a rule has been matched, a level 1 enrichment (e.g., parent company and merchant) and a level 2 enrichment (e.g., store location/online merchant) may be added to the enriched value, and the computer program may identify the particular level 1 and level 2 merchants as described below.

If the rule is a ZIP-MCC match or Default to headquarters match, the computer program may identify the merchant in the transaction as a child merchant, and may add that role to the enriched value. For example, the computer program may identify the particular level 2 merchant so that it can be added to the list of enrichments. If the merchant is an online merchant, the merchant enrichment must be unchanged. If there are multiple merchant locations (e.g., a coffee shop), the computer program may identify the particular location using, for example, the zip code for the transaction, so that the location specific details may be included in the enrichment.

If the rule is “ZIP MCC match” and details for the location are included, the enrichment details for that particular location may be identified. If there is not enough data for the particular location available, a zipless dummy record that does not include specific location data like address and geolocation, and is a back-up may be used.

The rules database may include a name pattern and a list of merchant category codes. If the raw transaction data matches a rule, then a matching merchant may be identified using the merchant names in the merchant name database.

If, in step 230, the computer program identifies a merchant match, in step 250, the computer program may enrich the raw transaction data with merchant contact information (e.g., phone number, email address, URL, etc.), store address, etc. The computer program may further include the normalized merchant name, the country, the latitude and longitude (used for features such as a map inlay in a user-facing application), logos, SIC description, city, state, zip code, etc.

If there is not a match, in step 235, the computer program may perform string distance matching on the raw transaction data. For example, the computer program may use the merchant name, MCC, and zip code from the raw transaction data to identify potential merchant matches, and may select the merchant match with the highest probability.

For example, a decision tree may be used with natural language processing (NLP) features to identify a merchant. For example, from a business name, industry name, telephone number, and zip code or geographic location, features such as Jaccard, Levenshtein, and context weighted words Jaccard may identify business features, Glo Ve embedding scores may be used to compare different industry names, and the first four digits of a zip code may be used.

In one embodiment, a decision tree may be trained to select the most important features for identifying a match, and may include rules-based cut-off points for each of the important features. Examples of decision tree features may include Jaccard weighted words similarity, binary if first three characters match, number of overlapping bitgrams between strings, a difference in character length, a number of overlapping trigrams between strings, embedding of consign similarity between MCC and SIC, Jaccard similarity of the phone number, Jaccard similarity between the first ten characters of both strings, and a difference in a number of bitgrams between the two strings.

The rules created by the decision tree may be used as the enhanced string distance method and may be hard coded as a series of if-then statements. A portion of an example table is as follows:

| | Step 1 | Step 2 | Step 3 | Step 4 |
|---|---|---|---|---|
| Rule 1 | Jaccard | first 3 | | |
| | Weighted | characters | | |
| | Words | match | | |
| | Similar- | | | |
| | ity >.705 | | | |
| Rule 2 | Jaccard | first 3 | Jaccard | |
| | Weighted | characters | Weighted | |
| | Words | match | Words | |
| | Similar- | | Similar- | |
| | ity >.705 | | ity >.879 | |
| Rule 3 | Jaccard | first 3 | Jaccard | # of |
| | Weighted | characters | Weighted | overlapping |
| | Words | match | Words | bigrams between |
| | Similar- | | Similar- | strings >12.5 |
| | ity >.705 | | ity <=.879 | |

. . .

If, in step 240, the computer program identifies a merchant match, in step 250, the computer program may enrich the raw transaction data.

If there is not a match, in step 245, the computer program may perform raw cleansing on the raw transaction data. For example, the data may be labeled as being raw cleansed.

In step 250, the computer program may output the updated transaction data (e.g., enriched or cleansed) to a downstream system, to an agent, to a customer, etc. In addition, the computer program may output merchant details to be displayed on a mobile application, a website, etc.

In one embodiment, the transaction data may be used in a search with fuzzy transaction searching functionality for customers to view their transaction history.

In embodiments, the transaction data may be used by bill aggregation team to identify recurring charges and subscriptions to allow customers to view and modify their subscriptions and recurring transaction.

In embodiments, the transaction data may be used by a rewards team to identify transactions at merchants that fit a rewards category, and to assign reward points.

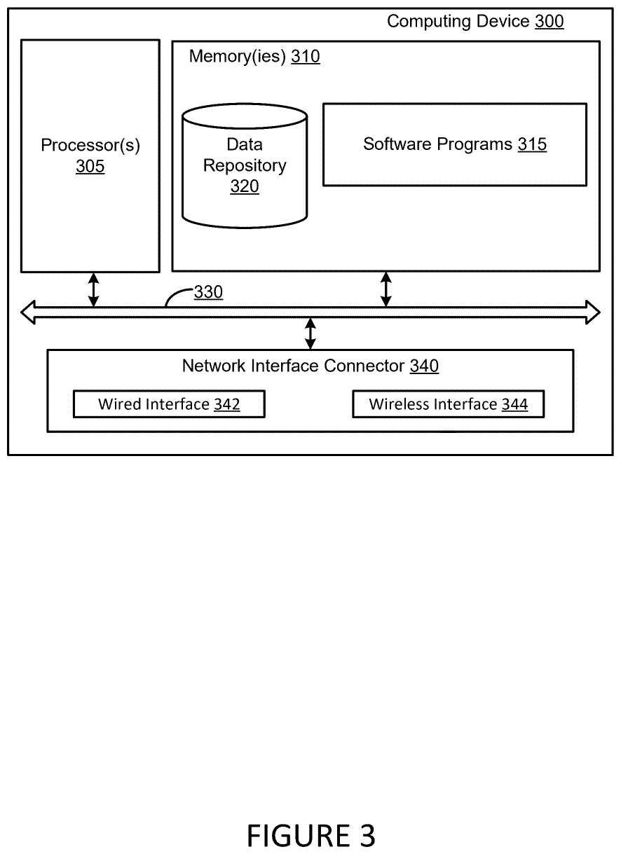

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments.

As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program, raw transaction data for a transaction, the transaction data comprising merchant fields, wherein the raw transaction data comprises payment card data for a payment card that was received at a point-of-sale device during a transaction between a customer and a merchant;
performing, by the computer program, data normalization on the merchant fields;
identifying, by the computer program, the merchant for the transaction based on one or more of the merchant fields;
enriching, by the computer program, a transaction record for the transaction with information for the merchant; and
outputting, by the computer program, the transaction record.

2. The method of claim 1, wherein the data normalization comprises removing, from the raw data, store numbers and order numbers.

3. The method of claim 1, wherein the data normalization comprises replacing, from the raw data, abbreviated or truncated words in the raw data with full words.

4. The method of claim 1, wherein the merchant is identified using string distance matching on the raw transaction data.

5. The method of claim 1, wherein the merchant is identified using a decision tree with natural language processing.

6. The method of claim 1, wherein enriching the transaction record with information for the merchant comprises adding merchant contact information for the merchant and/or adding merchant location information for the merchant to the transaction record.

7. The method of claim 1, wherein enriching the transaction record with information for the merchant comprises adding a parent for the merchant to the transaction record.

8. The method of claim 1, wherein the merchant is identified based on a merchant name matching a regular expression for the merchant name and the merchant fields matching a merchant city, a merchant state, and a merchant postal code for the merchant.

9. The method of claim 1, further comprising:
identifying, by the computer program, an intermediary prefix in one of the merchant fields;
identifying, by the computer program, an intermediary associated with the intermediary prefix; and
enriching, by the computer program, the transaction record for the transaction with information for the intermediary.

10. The method of claim 9, wherein enriching the transaction record with information for the intermediary comprises adding an intermediary identifier for the intermediary to the transaction record.

11. A non-transitory computer readable storage medium, including instructions stored thereon, which when read and executed by one or more computer processors, cause the one or more computer processors to perform steps comprising:
receiving raw transaction data for a transaction, the transaction data comprising merchant fields, wherein the raw transaction data comprises payment card data for a payment card that was received at a point-of-sale device during a transaction between a customer and a merchant;
performing data normalization on the merchant fields;
identifying the merchant for the transaction based on one or more of the merchant fields;
enriching a transaction record for the transaction with information for the merchant; and
outputting the transaction record.

12. The non-transitory computer readable storage medium of claim 11, wherein the data normalization comprises removing, from the raw data, store numbers and order numbers.

13. The non-transitory computer readable storage medium of claim 11, wherein the data normalization comprises replacing, from the raw data, abbreviated or truncated words in the raw data with full words.

14. The non-transitory computer readable storage medium of claim 11, wherein the merchant is identified using string distance matching on the raw transaction data.

15. The non-transitory computer readable storage medium of claim 11, wherein the merchant is identified using a decision tree with natural language processing.

16. The non-transitory computer readable storage medium of claim 11, wherein enriching the transaction record with information for the merchant comprises adding merchant contact information for the merchant and/or adding merchant location information for the merchant to the transaction record.

17. The non-transitory computer readable storage medium of claim 11, wherein enriching the transaction record with information for the merchant comprises adding a parent for the merchant to the transaction record.

18. The non-transitory computer readable storage medium of claim 11, wherein the merchant is identified based on a merchant name matching a regular expression for the merchant name and the merchant fields matching a merchant city, a merchant state, and a merchant postal code for the merchant.

19. The non-transitory computer readable storage medium of claim 11, further including instructions stored thereon, which when read and executed by the one or more computer processors, cause the one or more computer processors to perform steps comprising:
identifying an intermediary prefix in one of the merchant fields;
identifying an intermediary associated with the intermediary prefix; and
enriching the transaction record for the transaction with information for the intermediary.

20. The non-transitory computer readable storage medium of claim 19, wherein enriching the transaction record with information for the intermediary comprises adding an intermediary identifier for the intermediary to the transaction record.
